(19) United States
(12) Patent Application Publication
(10) Pub. No.: US 2025/0325992 A1
(43) Pub. Date: Oct. 23, 2025

(54) SWEEPING JET DEVICE WITH MULTIDIRECTIONAL OUTPUT

(71) Applicant: Ohio State Innovation Foundation, Columbus, OH (US)

(72) Inventor: Mehmet TOMAC, Worthington, OH (US)

(21) Appl. No.: 19/195,190

(22) Filed: Apr. 30, 2025

Related U.S. Application Data
(63) Continuation of application No. 17/776,908, filed on May 13, 2022, now Pat. No. 12,318,789.

(51) Int. Cl. B05B 1/08

(52) U.S. Cl. CPC B05B 1/08

(57) ABSTRACT

Various implementations include a sweeping jet device with multidirectional output. The device includes an interaction chamber defined by a chamber wall. The chamber wall defines first and second inlet ports and first and second outlet ports. First and second fluid supply inlets are configured to introduce first and second inlet fluid streams through the first and second inlet ports, respectively, and into the interaction chamber. First and second outlet nozzles are configured to discharge first and second outlet fluid streams from the interaction chamber through the first and second outlet ports and the first and second outlet nozzles, respectively. The first and second inlet fluid streams collide within the interaction chamber causing the first and second outlet fluid streams to sweep as the first and second outlet fluid streams are discharged from the first and second outlet nozzles, respectively.

### BACKGROUND

Jet interaction-type fluidic oscillators create an unsteady sweeping jet. The sweeping pattern of the jet depends primarily on the internal fluid dynamics of the oscillator itself. Fluidic oscillators are attracting increased interest to be used in various applications since they have no moving parts, yet they offer high control authority, sweeping over a wide range, and, due to their unique fluid distribution system, larger sweeping area capabilities for the same amount of fluid.

Currently, jet interaction-type fluidic oscillators include two fluid inputs and a single fluid output. In various applications, it may be desired to have fluid output from the device in multiple directions, requiring orientation of multiple jet interaction-type fluidic oscillators such that the fluid exiting the oscillators cover a multidirectional field. However, including multiple jet interaction-type fluidic oscillators in close proximity to each other may become cumbersome. Furthermore, in some applications it may be desired that the fluid output of each of the jet interaction-type fluidic oscillators be in communication with each other. However, if multiple jet interaction-type fluidic oscillators are used, each jet interaction-type fluidic oscillator will oscillate independently from the other jet interaction-type fluidic oscillators.

Thus, there is a desire for a jet interaction-type device capable of creating multidirectional sweeping outputs that are in communication with each other.

### SUMMARY

Various implementations include a sweeping jet device with multidirectional output. The device includes a first portion, a second portion, and a middle portion having a first side and a second side. The first side of the middle portion is coupled to the first portion, and the second side of the middle portion is coupled to the second portion. The middle portion includes an interaction chamber, a first fluid supply inlet, a second fluid supply inlet, a first outlet nozzle, and a second outlet nozzle. The interaction chamber is defined by a chamber wall extending between the first side and the second side of the middle portion. The chamber wall defines a first inlet port, a second inlet port, a first outlet port, and a second outlet port. The first fluid supply inlet is configured to introduce a first inlet fluid stream through the first inlet port and into the interaction chamber. The second fluid supply inlet is configured to introduce a second inlet fluid stream through the second inlet port and into the interaction chamber. The first outlet nozzle is configured to discharge a first outlet fluid stream from the interaction chamber through the first outlet port and the first outlet nozzle. The second outlet nozzle is configured to discharge a second outlet fluid stream from the interaction chamber through the second outlet port and the second outlet nozzle. The first inlet fluid stream collides with the second inlet fluid stream within the interaction chamber. The collision of the first inlet fluid stream with the second inlet fluid stream causes the first outlet fluid stream to sweep as the first outlet fluid stream is discharged from the first outlet nozzle and causes the second outlet fluid stream to sweep as the second outlet fluid stream is discharged from the second outlet nozzle.

In some implementations, the interaction chamber has a central axis extending perpendicular to the first side and second side of the middle portion, and each of the first inlet port, the second inlet port, the first outlet port, and the second outlet port is circumferentially spaced along the chamber wall at 90° around the central axis.

In some implementations, each of the first inlet port and the second inlet port are defined along the chamber wall between the first outlet port and the second outlet port, and each of the first outlet port and the second outlet port are defined along the chamber wall between the first inlet port and the second inlet port.

In some implementations, the first fluid supply inlet continuously introduces the first inlet fluid stream into the interaction chamber, and the second fluid supply inlet continuously introduces the second inlet fluid stream into the interaction chamber.

In some implementations, the first fluid supply inlet introduces the first inlet fluid stream into the interaction chamber at a constant flow rate, and the second fluid supply inlet introduces the second inlet fluid stream into the interaction chamber at a constant flow rate. In some implementations, the first inlet fluid stream and the second inlet fluid stream have the same flow rate.

In some implementations, the first inlet fluid stream and the second inlet fluid stream comprise a liquid.

In some implementations, the first inlet fluid stream and the second inlet fluid stream comprise a gas.

Various other implementations include a sweeping jet device with multidirectional output. The device includes a first portion, a second portion, and a middle portion having a first side and a second side. The first side of the middle portion is coupled to the first portion, and the second side of the middle portion is coupled to the second portion. The middle portion includes an interaction chamber, at least two fluid supply inlets, and at least two outlet nozzles. The interaction chamber is defined by a chamber wall extending between the first side and the second side of the middle portion. The chamber wall defines at least two inlet ports and at least two outlet ports. Each of the at least two fluid supply inlets is configured to introduce one of at least two inlet fluid streams through a respective one of the at least two inlet ports and into the interaction chamber. Each of the at least two outlet nozzles is configured to discharge one of at least two outlet fluid streams from the interaction chamber through a respective one of the at least two outlet ports and through the outlet nozzle. The at least two inlet fluid streams collide with each other within the interaction chamber. The collision of the at least two inlet fluid streams with each other causes each of the at least two outlet fluid streams to sweep as the at least two outlet fluid streams are discharged from respective outlet nozzles.

In some implementations, the interaction chamber has a central axis extending perpendicular to the first side and second side of the middle portion, and each of the at least two inlet ports and at least two outlet ports is circumferentially spaced along the chamber wall at 360°/N around the central axis. N is the total number of inlet ports and outlet ports. In some implementations, N=6. In some implementations, N=8.

In some implementations, each of the at least two inlet ports is defined along the chamber wall between two adjacent outlet ports, and each of the at least two outlet ports is defined along the chamber wall between two adjacent inlet ports.

In some implementations, each of the at least two fluid supply inlets continuously introduces one of the at least two inlet fluid streams into the interaction chamber.

In some implementations, each of the at least two fluid supply inlets introduces one of the at least two inlet fluid streams into the interaction chamber at a constant flow rate. In some implementations, each of the at least two inlet fluid streams has the same flow rate.

In some implementations, each of the at least two inlet fluid streams comprises a liquid.

In some implementations, each of the at least two inlet fluid streams comprises a gas.

### BRIEF DESCRIPTION OF DRAWINGS

Example features and implementations are disclosed in the accompanying drawings. However, the present disclosure is not limited to the precise arrangements and instrumentalities shown. Similar elements in different implementations are designated using the same reference numerals.

FIG. 1A is a top view of a jet interaction-type fluidic oscillator of the prior art.

FIG. 1B is an end view of the jet interaction-type fluidic oscillator of FIG. 1A.

FIG. 2A is a top view of a sweeping jet device with multidirectional output, according to one implementation.

FIG. 2B is an end view of the sweeping jet device of FIG. 2A.

FIG. 2C is a top view of the sweeping jet device of FIG. 2A with the outlet fluid streams swept in the opposite direction.

FIG. 2D is a top view of the sweeping jet device of FIG. 2A with a time average of the sweeping outlet fluid streams.

FIG. 3 is a top view of a sweeping jet device with multidirectional output, according to another implementation.

FIG. 4 is a top view of a sweeping jet device with multidirectional output, according to another implementation.

FIG. 5 is a top view of a sweeping jet device with multidirectional output, according to another implementation.

### DETAILED DESCRIPTION

The devices, systems, and methods disclosed herein provide for a sweeping jet device capable of creating multiple sweeping outputs. The outputs are multidirectional and can provide a 360° output coverage.

Various implementations include a sweeping jet device with multidirectional output. The device includes a first portion, a second portion, and a middle portion having a first side and a second side. The first side of the middle portion is coupled to the first portion, and the second side of the middle portion is coupled to the second portion. The middle portion includes an interaction chamber, a first fluid supply inlet, a second fluid supply inlet, a first outlet nozzle, and a second outlet nozzle. The interaction chamber is defined by a chamber wall extending between the first side and the second side of the middle portion. The chamber wall defines a first inlet port, a second inlet port, a first outlet port, and a second outlet port. The first fluid supply inlet is configured to introduce a first inlet fluid stream through the first inlet port and into the interaction chamber. The second fluid supply inlet is configured to introduce a second inlet fluid stream through the second inlet port and into the interaction chamber. The first outlet nozzle is configured to discharge a first outlet fluid stream from the interaction chamber through the first outlet port and the first outlet nozzle. The second outlet nozzle is configured to discharge a second outlet fluid stream from the interaction chamber through the second outlet port and the second outlet nozzle. The first inlet fluid stream collides with the second inlet fluid stream within the interaction chamber. The collision of the first inlet fluid stream with the second inlet fluid stream causes the first outlet fluid stream to sweep as the first outlet fluid stream is discharged from the first outlet nozzle and causes the second outlet fluid stream to sweep as the second outlet fluid stream is discharged from the second outlet nozzle.

Various other implementations include a sweeping jet device with multidirectional output. The device includes a first portion, a second portion, and a middle portion having a first side and a second side. The first side of the middle portion is coupled to the first portion, and the second side of the middle portion is coupled to the second portion. The middle portion includes an interaction chamber, at least two fluid supply inlets, and at least two outlet nozzles. The interaction chamber is defined by a chamber wall extending between the first side and the second side of the middle portion. The chamber wall defines at least two inlet ports and at least two outlet ports. Each of the at least two fluid supply inlets is configured to introduce one of at least two inlet fluid streams through a respective one of the at least two inlet ports and into the interaction chamber. Each of the at least two outlet nozzles is configured to discharge one of at least two outlet fluid streams from the interaction chamber through a respective one of the at least two outlet ports and through the outlet nozzle. The at least two inlet fluid streams collide with each other within the interaction chamber. The collision of the at least two inlet fluid streams with each other causes each of the at least two outlet fluid streams to sweep as the at least two outlet fluid streams are discharged from respective outlet nozzles.

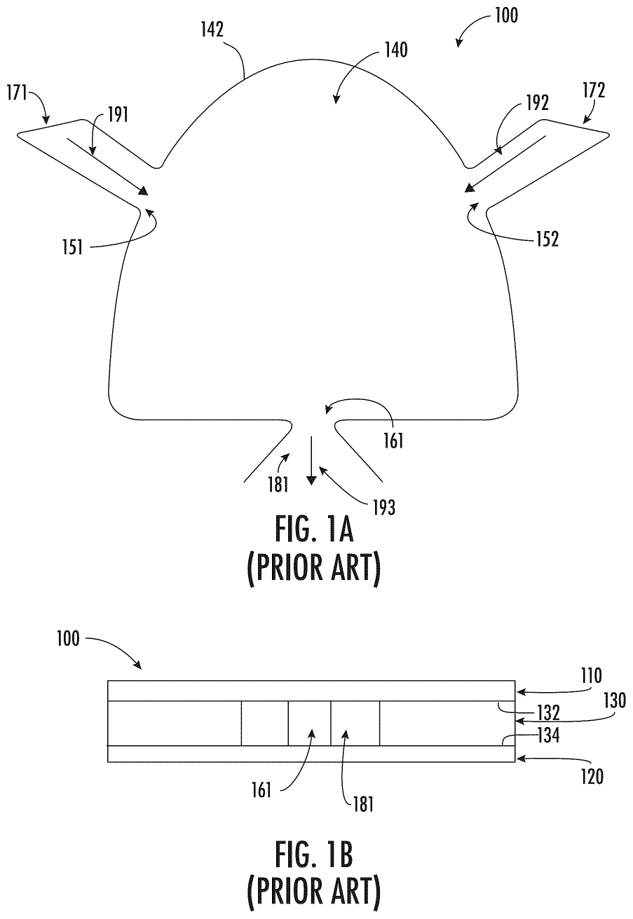

FIG. 1A shows a top view of a jet interaction-type fluidic oscillator 100 of the prior art, and FIG. 1B shows an end view of the jet interaction-type fluidic oscillator 100 of the prior art as viewed from the outlet nozzle 181 of the middle portion 130. The jet interaction-type fluidic oscillator 100 includes a first portion 110, a second portion 120, and a middle portion 130 disposed between the first portion 110 and the second portion 120. The middle portion 130 includes a first side 132, a second side 134 opposite and spaced apart from the first side 132, and a chamber wall 142 extending from the first side 132 to the second side 134. The chamber wall 142 defines an interaction chamber 140. The chamber wall 142 defines a first inlet port 151, a second inlet port 152, and an outlet port 161. The middle portion 130 of the fluidic oscillator 100 further includes a first fluid supply inlet 171, a second fluid supply inlet 172, and an outlet nozzle 181. The first fluid supply inlet 171 is in fluid communication with the interaction chamber 140 via the first inlet port 151, the second fluid supply inlet 172 is in fluid communication with the interaction chamber 140 via the second inlet port 152, and the outlet nozzle 181 is in fluid communication with the interaction chamber 140 via the outlet port 161.

A first fluid stream 191 enters the interaction chamber 140 of the fluidic oscillator 100 through the first fluid supply inlet 171, through the first inlet port 151, through the interaction chamber 140, and exits the fluidic oscillator 100 through the outlet port 161 and the outlet nozzle 181. Simultaneously, a second fluid stream 192 enters the fluidic oscillator 100 through the second fluid supply inlet 172, through the second inlet port 152, through the interaction chamber 140, and exits the fluidic oscillator 100 through the outlet port 161 and the outlet nozzle 181. The first fluid stream 191 and second fluid stream 192 are angled to collide with each other in the interaction chamber 140. As the first fluid stream 191 and second fluid stream 192 collide in the interaction chamber 140, the fluid stream 193 exiting the interaction chamber 140 through the outlet port 161 and the outlet nozzle 181 oscillates in a plane parallel to the first side 132 of the middle portion 130.

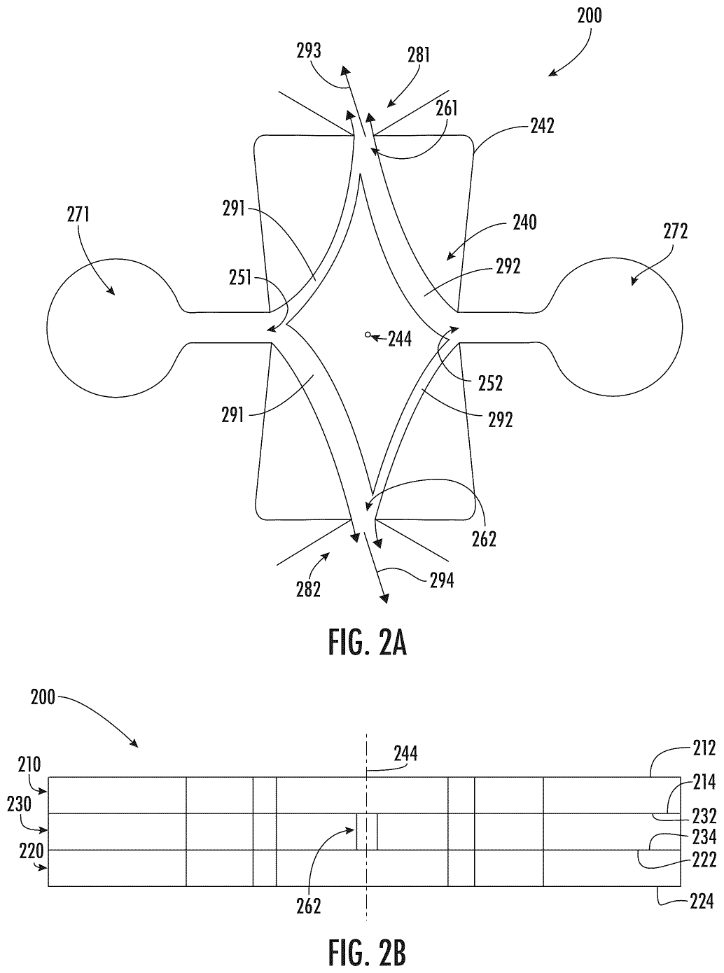

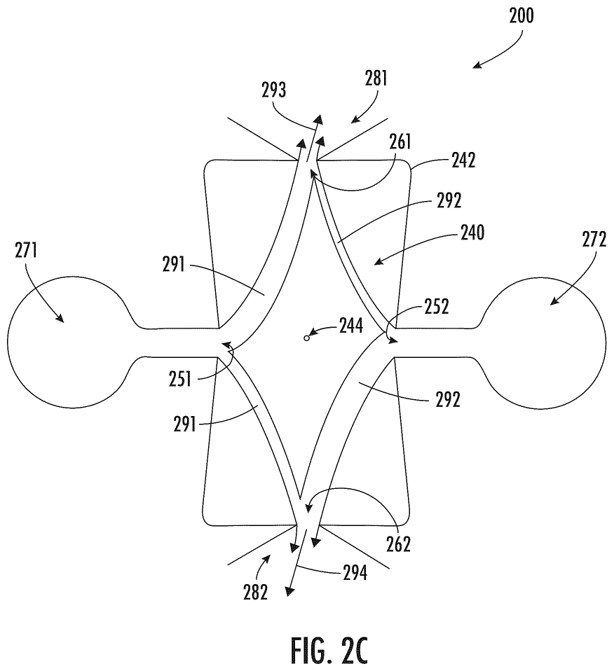

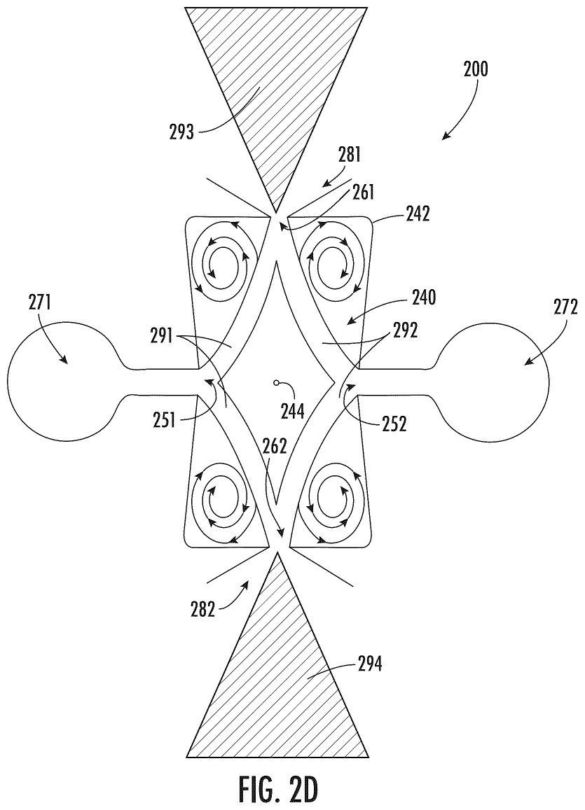

FIG. 2A-D shows a sweeping jet device 200 with multidirectional output according to one implementation of the current application. The device 200 includes a first portion 210, a second portion 220, and a middle portion 230. The first portion 210 has a first side 212 and a second side 214 opposite and spaced apart from the first side 212 of the first portion 210, the second portion 220 has a first side 222 and a second side 224 opposite and spaced apart first side 222 of the first portion 210, and the middle portion 230 has a first side 232 and a second side 234 opposite and spaced apart first side 232 of the middle portion 230. Second side 214 of the first portion 210 is coupled to the first side 232 of the middle portion 230, and the second side 234 of the middle portion 230 is coupled to the first side 222 of the second portion 220.

The middle portion 230 includes a chamber wall 242 that, along with the second side 214 of the first portion 210 and the first side 222 of the second portion 220, define an interaction chamber 240 through which fluid can flow. The chamber wall 242 defines a first inlet port 251, a second inlet port 252, a first outlet port 261, and a second outlet port 262.

The middle portion 230 further includes a first fluid supply inlet 271 and a second fluid supply inlet 272. The first fluid supply inlet 271 is coupled to the first inlet port 251 and is in fluid communication with the interaction chamber 240 through the first inlet port 251. The second fluid supply inlet 272 is coupled to the second inlet port 252 and is in fluid communication with the interaction chamber 240 through the second inlet port 252. The first fluid supply inlet 271 is configured to supply a first inlet fluid stream 291, through the first inlet port 251, and into the interaction chamber 240. The second fluid supply inlet 272 is configured to supply a second inlet fluid stream 292, through the second inlet port 252, and into the interaction chamber 240. The fluid supply inlets 271, 272 and inlet ports 251, 252 are shaped such that the first inlet fluid stream 291 and the second inlet fluid stream 292 collide with each other within the interaction chamber 240.

The first and second fluid supply inlets 271, 272 shown in FIG. 2A-D continuously introduce the first and second inlet fluid streams 291, 292, respectively, into the interaction chamber 240, but in other implementations, one or both of the first and second fluid supply inlets introduce the first and second inlet fluid streams discontinuously to change the sweeping of the first and second outlet fluid streams as they exit the outlet nozzles, as discussed below. The first and second fluid supply inlets 271, 272 shown in FIG. 2A-D introduce the first and second inlet fluid streams 291, 292, respectively, into the interaction chamber 240 at a constant flow rate, but in other implementations, one or both of the first and second fluid supply inlets introduce the first and second inlet fluid streams at varying flow rates to change the sweeping of the first and second outlet fluid streams as they exit the outlet nozzles, as discussed below. The first inlet fluid stream 291 and the second inlet fluid stream 292 shown in FIG. 2A-D have the same flow rate, but in other implementations, the first inlet fluid stream and the second inlet fluid stream have different flow rates.

The middle portion 230 also includes a first outlet nozzle 281 and a second outlet nozzle 282. The first outlet nozzle 281 is coupled to the first outlet port 261 and is in fluid communication with the interaction chamber 240 through the first outlet port 261. The second outlet nozzle 282 is coupled to the second outlet port 262 and is in fluid communication with the interaction chamber 240 through the second outlet port 262. The first outlet nozzle 281 is configured to discharge a first outlet fluid stream 293 comprised of portions of the first and second inlet fluid streams 291, 292 from the interaction chamber 240, through the first outlet port 261, and out of the device 200. The second outlet nozzle 282 is configured to discharge a second outlet fluid stream 294 comprised of portions of the first and second inlet fluid streams 291, 292 from the interaction chamber 240, through the second outlet port 262, and out of the device 200.

The collision of the inlet fluid streams 291, 292 within the interaction chamber 240 causes each of the inlet fluid streams 291, 292 to bifurcate, as shown in FIGS. 2A, 2C, and 2D. Because of the unsteady nature of the inlet fluid streams 291, 292 as they enter the interaction chamber 240, a varying portion of each inlet fluid stream 291, 292 flows toward each adjacent outlet port 261, 262. In some instances, one portion of an inlet fluid stream 291, 292 may be zero such that the inlet fluid stream 291, 292 may not bifurcate, and the entirety of the inlet fluid stream 291, 292 flows toward one adjacent outlet port 261, 262 and none of the inlet fluid stream 291, 292 flows toward the other adjacent outlet port 261, 262. As the unsteady inlet fluid streams 291, 292 collide in the interaction chamber 240, the flow rate of each portion of each bifurcated inlet fluid stream 291, 292 varies. Each portion of each of the inlet fluid streams 291, 292 flows to an adjacent outlet port 261, 262 and combine to form the fluid outlet stream 293, 294 exiting the outlet port 261, 262 and respective outlet nozzle 281, 282. As seen in FIGS. 2A, 2C, and 2D, a portion of the first inlet fluid stream 291 and a portion of the second inlet fluid stream 292 combine to form the first outlet fluid stream 293, and the other portion of the first inlet fluid stream 291 and the other portion of the second inlet fluid stream 292 combine to form the second outlet fluid stream 294.

When the flow rate of one of the portions of an inlet stream 291, 292 is greater than the flow rate of the portion of the other adjacent inlet stream 291, 292, the portion of the inlet stream 291, 292 with the greater flow rate will cause the resulting outlet stream 261, 262 to exit the outlet nozzle 281, 282 at an angle directed away from the greater flow rate portion and representative of the proportions of the flow rates of the two portions combining to create the outlet fluid stream 293, 294.

For example, the device 200 in FIG. 2A shows that the first outlet fluid stream 293 receives a higher flow rate portion from the second inlet fluid stream 292 than from the first inlet fluid stream 291, and the second outlet fluid stream 294 receives a higher flow rate portion from the first inlet fluid stream 291 than from the second inlet fluid stream 292. However, because the inlet fluid streams 291, 292 are unsteady, the flow rate of each of the bifurcated portions of the inlet fluid streams 291, 292 vary over time, causing the proportions of flow rates creating the outlet fluid stream 293, 294 to vary. FIG. 2C shows the same device 200 as in FIG. 2A, but in FIG. 2C, the unsteady inlet fluid streams 291, 292 have changed such that the first outlet fluid stream 293 now receives a higher flow rate portion from the first inlet fluid stream 291 than from the second inlet fluid stream 292, and the second outlet fluid stream 294 receives a higher flow rate portion from the second inlet fluid stream 292 than from the first inlet fluid stream 291. As seen in a comparison of FIG. 2A and FIG. 2C, the variation in flow rates of the portions of the inlet fluid streams 291, 292 causes the angle of the resulting outlet streams 293, 294 to vary, causing the outlet fluid streams 293, 294 to sweep from side to side over time. FIG. 2D shows a time average of the sweeping outlet fluid streams 293, 294 of the device 200 shown in FIGS. 2A-2C.

The spacing and configuration of the inlet ports 251, 252, fluid supply inlets 271, 272, outlet ports 261, 262, and outlet nozzles 281, 282 can be altered to achieve different sweeping effects. Each of the first inlet port 251 and the second inlet port 252 shown in FIG. 2A-D are defined along the chamber wall 242 between the first outlet port 261 and the second outlet port 262, and each of the first outlet port 261 and the second outlet port 262 are defined along the chamber wall between the first inlet port 251 and the second inlet port 252. The interaction chamber 240 shown in FIG. 2A-D has a central axis 244 extending perpendicular to the first side 232 and second side 234 of the middle portion 230. Each of the first inlet port 251, the second inlet port 252, the first outlet port 261, and the second outlet port 262 is circumferentially spaced along the chamber wall 242 at 90° around the central axis 244. Thus, the first inlet port 251, the second inlet port 252, the first outlet port 261, and the second outlet port 262 of the device 200 shown in FIG. 2A-D are disposed equally spaced along the chamber wall 242. However, in other implementations, the inlet ports and outlet ports are arranged in any order and spacing to achieve a desired sweeping effect.

The first inlet fluid stream 291 and the second inlet fluid stream 292 shown in FIG. 2A-D include a liquid, but in other implementations, the first inlet fluid stream and the second inlet fluid stream are a gas.

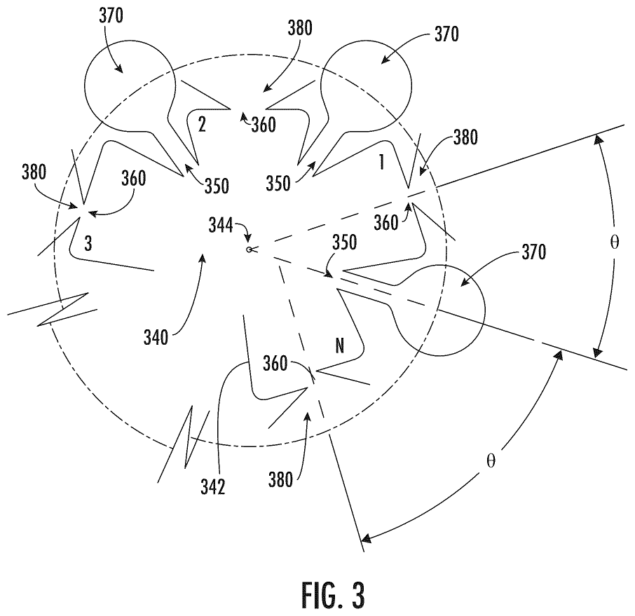

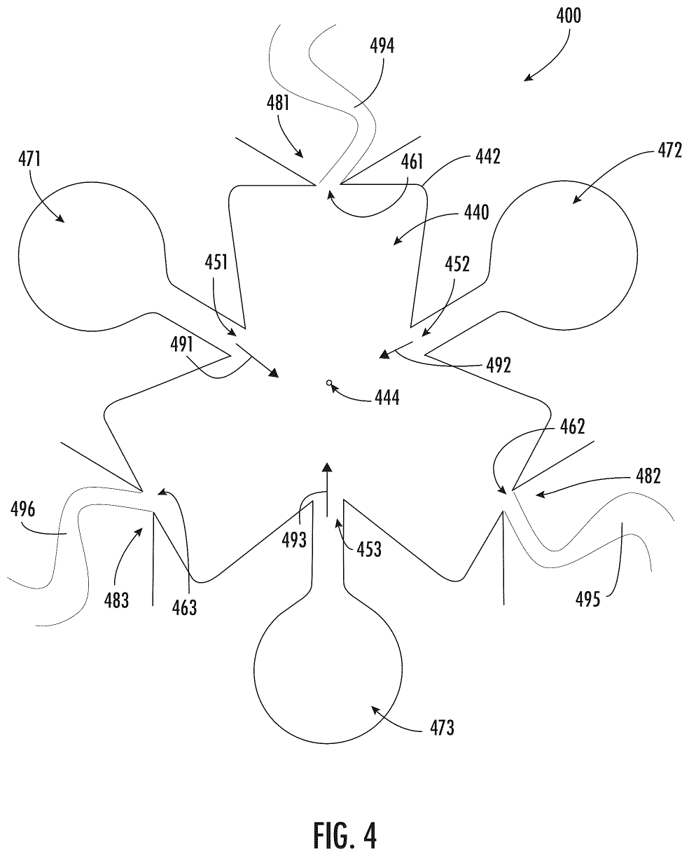

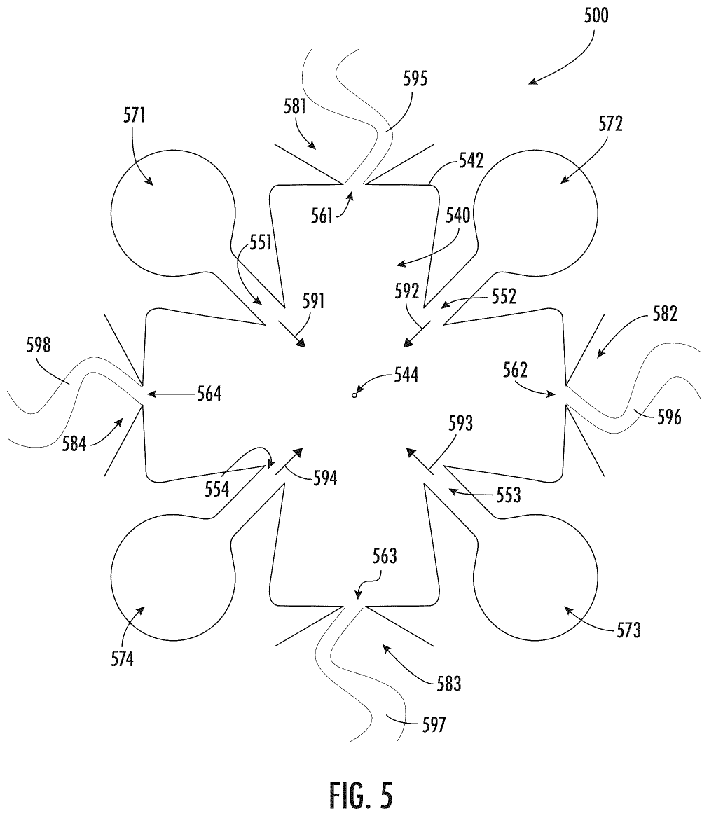

Although the device 200 shown in FIG. 2A-D includes first and second inlet ports 251, 252, first and second outlet ports 261, 262, first and second fluid supply inlets 271, 272, and first and second outlet nozzles 281, 282, in other implementations, the device can include any number of two or more inlet ports, outlet ports, fluid supply inlets, and outlet nozzles. FIG. 3 shows a sweeping jet device 300 having N total inlet ports 350 and outlet ports 360 and N total fluid supply inlets 370 and outlet nozzles 380, wherein N is a number four or more. Similar reference numbers are employed in FIG. 3 for designating similar elements shown in FIG. 2. FIG. 4 shows a sweeping jet device 400 wherein N equals six such that the device 400 has three inlet ports 451, 452, 453, three outlet ports 461, 462, 463, three fluid supply inlets 471, 472, 473, and three outlet nozzles 481, 482, 483. Similar reference numbers are employed in FIG. 4 for designating similar elements shown in FIG. 2. FIG. 5 shows a sweeping jet device 500 wherein N equals eight such that the device 500 has four inlet ports 551, 552, 553, 554, four outlet ports 561, 562, 563, 564, four fluid supply inlets 571, 572, 573, 574, and four outlet nozzles 581, 582, 583, 584. Similar reference numbers are employed in FIG. 5 for designating similar elements shown in FIG. 2. As shown in FIG. 3, the interaction chamber 340 has a central axis 344 extending perpendicular to the first side 332 and second side 334 of the middle portion 330, and each of the at least two inlet ports 350 and at least two outlet ports 360 is circumferentially spaced along the chamber wall 342 at θ=360°/N around the central axis 344. However, as stated above, in other implementations, the inlet and outlet ports are spaced and disposed in any order along the chamber wall.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

1-18. (Canceled)

19. A sweeping jet device with multidirectional output, the device comprising:
an interaction chamber defined by a chamber wall extending between a first side and a second side of the device, wherein the chamber wall defines a first inlet port and a second inlet port;
a first fluid supply inlet configured to introduce a first inlet fluid stream through the first inlet port and into the interaction chamber;
a second fluid supply inlet configured to introduce a second inlet fluid stream through the second inlet port and into the interaction chamber; and
an outlet nozzle configured to discharge an outlet fluid stream from the interaction chamber through an outlet port and the outlet nozzle, wherein the outlet nozzle extends in a direction perpendicular to both the first inlet port and the second inlet port;
wherein the first inlet fluid stream collides with the second inlet fluid stream within the interaction chamber, and
wherein the collision of the first inlet fluid stream with the second inlet fluid stream causes the outlet fluid stream to sweep as the outlet fluid stream is discharged from the outlet nozzle, creating a multidirectional output.

20. The sweeping jet device of claim 19, wherein the outlet nozzle is aligned with a central longitudinal axis of the sweeping jet device.

21. The sweeping jet device of claim 19, wherein the multidirectional, sweeping output of the outlet fluid stream is angled to be directed away from the first and second inlet ports.

22. The sweeping jet device of claim 19, further comprising a third inlet port defined by the chamber wall, wherein a third fluid supply inlet is configured to introduce a third inlet fluid stream through the third inlet port and into the interaction chamber, wherein the third inlet fluid stream collides with the first and second inlet fluid streams.

23. The sweeping jet device of claim 22, wherein the outlet nozzle extends in a direction perpendicular to the third inlet port.

24. The sweeping jet device of claim 22, further comprising a fourth inlet port defined by the chamber wall, wherein a fourth fluid supply inlet is configured to introduce a fourth inlet fluid stream through the fourth inlet port and into the interaction chamber, wherein the fourth inlet fluid stream collides with the first, second, and third inlet fluid streams.

25. The sweeping jet device of claim 24, wherein the first, second, third, and fourth inlet ports are spaced circumferentially along the chamber wall.

26. The sweeping jet device of claim 19, wherein the first fluid supply inlet continuously introduces the first inlet fluid stream into the interaction chamber and the second fluid supply inlet continuously introduces the second inlet fluid stream into the interaction chamber.

27. The sweeping jet device of claim 19, wherein the first fluid supply inlet introduces the first inlet fluid stream into the interaction chamber at a constant flow rate and the second fluid supply inlet introduces the second inlet fluid stream into the interaction chamber at a constant flow rate.

28. The sweeping jet device of claim 27, wherein the first inlet fluid stream and the second inlet fluid stream have the same flow rate.

29. The sweeping jet device of claim 19, wherein one or both of the first and second fluid supply inlets introduce the first and second fluid streams discontinuously to change the sweeping of the outlet fluid stream exiting the outlet nozzle.

30. The sweeping jet device of claim 19, wherein one or both of the first and second fluid supply inlets introduce the first and second inlet fluid streams at varying flow rates to change the sweeping of the outlet fluid stream exiting the outlet nozzle.

31. The sweeping jet device of claim 19, wherein the first inlet fluid stream and the second inlet fluid stream comprise a liquid.

32. The sweeping jet device of claim 19, wherein the first inlet fluid stream and the second inlet fluid stream comprise a gas.

33. The sweeping jet device of claim 19, further comprising a first portion, a second portion, and a middle portion having the first side and the second side, the first side of the middle portion being coupled to the first portion and the second side of the middle portion being coupled to the second portion, the middle portion comprising the interaction chamber defined by the chamber wall.
